(19) United States
(12) Patent Application Publication
(10) Pub. No.: US 2022/0197478 A1
(43) Pub. Date: Jun. 23, 2022

(54) METHOD FOR CURSOR CONTROL, ELECTRONIC DEVICE AND STORAGE MEDIUM

(71) Applicant: BEIJING XIAOMI MOBILE SOFTWARE CO., LTD., Beijing (CN)

(72) Inventors: Runhua GUO, Beijing (CN); Lin FAN, Beijing (CN); Sai ZHANG, Beijing (CN)

(73) Assignee: BEIJING XIAOMI MOBILE SOFTWARE CO., LTD., Beijing (CN)

(21) Appl. No.: 17/334,381

(22) Filed: May 28, 2021

(30) Foreign Application Priority Data
Dec. 23, 2020 (CN) 202011545904.4

(51) Int. Cl. G06F 3/0481; G06F 3/0488; G06F 3/041; G06F 3/01

(52) U.S. Cl. CPC G06F 3/04812; G06F 3/04886; G06F 2203/04105; G06F 3/016; G06F 3/0414

(57) ABSTRACT

The present disclosure provides a method for cursor control and an electronic device. The method includes that a cursor control area is displayed in an interface in response to a display instruction of the cursor control area. The cursor control area includes a displacement area and a continuous movement area surrounding the displacement area. The cursor control area further comprises a control identifier capable of moving in the cursor control area. The cursor is controlled to move in the interface in response to a movement operation on the control identifier. When the control identifier moves in the displacement area, a cursor velocity at which the cursor moves in the interface is associated with a control identifier velocity at which the control identifier moves. When the control identifier moves from the displacement area to the continuous movement area, the cursor moves in the interface at a first velocity.

### CROSS-REFERENCE TO RELATED APPLICATION

This application is based upon and claims priority to Chinese Patent Application No. 202011545904.4, filed on Dec. 23, 2020, the content of which is hereby incorporated by reference in its entirety for all purposes.

### TECHNICAL FIELD

The disclosure relates to the technical field of electronic devices, and more specifically, to a method for cursor control, an electronic device and a storage medium.

### BACKGROUND

Movement of a cursor is needed during page browsing or content editing. For some electronic devices, a user may move the cursor with a finger to adjust the position of the cursor.

### SUMMARY

The disclosure provides a method and apparatus for cursor control, an electronic device and a storage medium.

According to a first aspect of embodiments of the disclosure, a method for cursor control is provided. The method may include that an electronic device displays a cursor control area in an interface in response to a display instruction of a cursor control area. The electronic device includes a touch screen that displays the interface on the touch screen, the interface includes a cursor. The cursor control area includes a displacement area and a continuous movement area surrounding the displacement area. The cursor control area includes a control identifier that is capable of moving in the cursor control area.

Additionally, the method may include that the electronic device controls the cursor to move in the interface in response to determining that a movement operation on the control identifier. Further, the method may include that the electronic device may associate a cursor velocity at which the cursor moves in the interface with a control identifier velocity at which the control identifier moves in response to determining that the control identifier moves in the displacement area. Moreover, the electronic device may move the cursor in the interface at a first velocity in response to determining that the control identifier moves from the displacement area to the continuous movement area.

According a second aspect of the embodiments of the disclosure, an electronic device is provided. The electronic device may include a processor and a memory configured to store instructions executable by the processor.

The processor may be configured to display a cursor control area in an interface in response to a display instruction of the cursor control area. The electronic device includes a touch screen that displays the interface on the touch screen, the interface includes a cursor. The cursor control area includes a displacement area and a continuous movement area surrounding the displacement area. Further, the cursor control area includes a control identifier capable of moving in the cursor control area.

Moreover, the processor may be configured to: control the cursor to move in the interface in response to a movement operation on the control identifier; associate a cursor velocity at which the cursor moves in the interface with a control identifier velocity at which the control identifier moves in response to determining that the control identifier moves in the displacement area; and moves the cursor in the interface at a first velocity in response to determining that the control identifier moves from the displacement area to the continuous movement area.

According a third aspect of the embodiments of the disclosure, a computer-readable storage medium is provided. The computer-readable storage medium stores thereon a computer program which, when performed by a processor, implements acts including displaying a cursor control area in an interface displayed on a touch screen of the electronic device in response to a display instruction of the cursor control area. The cursor control area includes a displacement area and a continuous movement area surrounding the displacement area, and the cursor control area includes a control identifier capable of moving in the cursor control area.

Further, the computer program may implement acts further including: controlling a cursor in the interface to move in the interface in response to a movement operation on the control identifier; associating a cursor velocity at which the cursor moves in the interface with a control identifier velocity at which the control identifier moves in response to determining that the control identifier moves in the displacement area; and moving the cursor in the interface at a first velocity in response to determining that the control identifier moves from the displacement area to the continuous movement area.

It is to be understood that the above general description and the detailed description below are merely exemplary and explanatory and are not intended to limit the disclosure.

### BRIEF DESCRIPTION OF THE DRAWINGS

The accompanying drawings referred to in the specification are a part of this disclosure, and provide illustrative embodiments consistent with the disclosure and, together with the detailed description, serve to illustrate some embodiments of the disclosure.

FIG. 1 is a flowchart showing a method for cursor control according to some embodiments of the present disclosure.

FIG. 2 is a flowchart showing another method for cursor control according to some embodiments of the present disclosure.

FIG. 3A is a schematic diagram showing a text editing interface according to some embodiments of the present disclosure.

FIG. 3B is a schematic diagram showing a text editing interface displayed with a cursor control area according to some embodiments of the present disclosure.

FIG. 3C is a schematic diagram showing another text editing interface displayed with a cursor control area according to some embodiments of the present disclosure.

FIG. 3D is a schematic diagram showing still another text editing interface displayed with a cursor control area according to some embodiments of the present disclosure.

FIG. 3E is a schematic diagram showing a plain text interface according to some embodiments of the present disclosure.

FIG. 4 is a structure schematic diagram of a cursor control apparatus according to some embodiments of the present disclosure.

FIG. 5 is a block diagram of an apparatus for cursor control according to some embodiments of the present disclosure.

### DETAILED DESCRIPTION

Exemplary embodiments (examples of which are illustrated in the accompanying drawings) are elaborated below. The following description refers to the accompanying drawings, in which identical or similar elements in two drawings are denoted by identical reference numerals unless indicated otherwise. The exemplary implementation modes may take on multiple forms, and should not be taken as being limited to examples illustrated herein. Instead, by providing such implementation modes, embodiments herein may become more comprehensive and complete, and comprehensive concept of the exemplary implementation modes may be delivered to those skilled in the art. Implementations set forth in the following exemplary embodiments do not represent all implementations in accordance with the subject disclosure. Rather, they are merely examples of the apparatus and method in accordance with certain aspects herein as recited in the accompanying claims.

Movement of a cursor is needed during page browsing or content editing. For some electronic devices, a user may move the cursor with a finger to adjust the position of the cursor. When moving the cursor in such a manner, the finger may occlude the position of the cursor, which is inconvenient for adjusting the cursor to a target position, and the error rate is high. Hence, the existing manner of cursor moving has a relatively low efficiency.

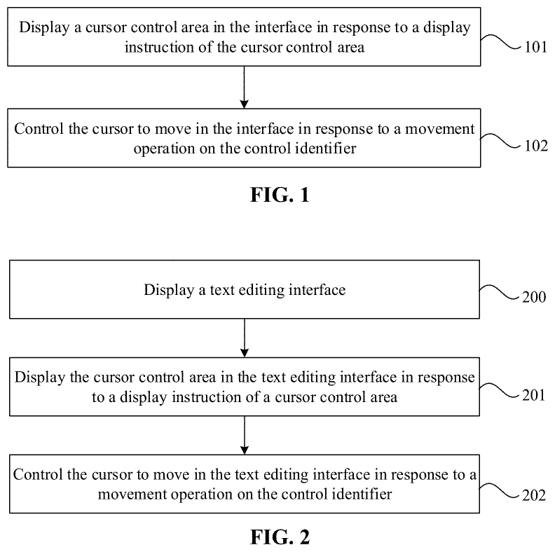

FIG. 1 is a flowchart showing a method for cursor control according to some embodiments of the present disclosure. The method may be applied to an electronic device having a touch screen. The electronic device may include but is not limited to mobile phones, tablets, notebooks, personal digital assistants (PDAs), wearable devices (such as smart glasses and smartwatches), etc. The electronic device may be installed with various applications such as a browser, e-book and instant messaging. When a user browses the application interfaces and edits a text in the interface, there is a need to move the cursor displayed in the interface and locate the cursor to a target position. The specific implementation for controlling a movement of the cursor are described below.

Referring to FIG. 1, the method may include Block 101 and Block 102.

In Block 101, a cursor control area is displayed in an interface in response to a display instruction of the cursor control area.

The interface may be an interface including a plain text, an interface including a text and a picture, or further an interface including a text editing area.

The display instruction of the cursor control area may be triggered when the user performs a target operation in the interface. In order to facilitate the user operation, the cursor control area may be displayed at a position convenient for the user operation. For example, when the electronic device is held by the user, the cursor control area may be displayed at an edge of the interface close to a wrist of the user, and the finger of the user may perform an operation such as clicking, pressing, or sliding easily at the edge of the interface. The edge area of the interface is referred to as a finger operation hot area.

A control identifier is further provided in the cursor control area. The control identifier may move in the cursor control area. An association relationship between the control identifier and the cursor displayed in the interface is established in advance, such that a movement of the cursor may be controlled through a movement of the control identifier.

The cursor control area includes a displacement area and a continuous movement area surrounding the displacement area. When the control identifier moves in the displacement area, a velocity at which the cursor moves in the interface is associated with a velocity at which the control identifier moves; and when the control identifier moves from the displacement area to the continuous movement area, the cursor moves in the interface at a first velocity. The first velocity may be a preset fixed value. The first velocity may be alternatively determined according to a velocity at which the user moves the control identifier. For example, the first velocity is slightly greater than a maximum velocity at which the control identifier moves in the displacement area. A difference between the first velocity and the maximum velocity may be set to a fixed value according to an actual need.

In Block 102, the cursor is controlled to move in the interface in response to a movement operation on the control identifier.

The movement operation may be, for example, a sliding operation(s). The velocity at which the control identifier moves in the displacement area is associated with the sliding operation(s). When detecting that the user performs the sliding operation(s) in the displacement area, the electronic device controls the control identifier to move along a direction consistent with the sliding operation(s); and the faster the user slides on the touch screen, the faster the control identifier moves. When the control identifier moves in the displacement area, the velocity at which the cursor moves in the interface is associated with the velocity at which the control identifier moves, and the faster the control identifier moves, the faster the cursor moves in the interface correspondingly. The correspondence relationship between the length for which the user slides on the touch screen and the distance for which the control identifier moves, and the correspondence relationship between the distance for which the control identifier moves and the distance for which the cursor moves may be set autonomously according to an actual need. For example, whenever the user slides for a length of two pixels on the touch screen, the control identifier moves for a distance of two pixels and the cursor moves for a distance of one character.

The movement operation may be, for example, a clicking operation(s). The velocity at which the control identifier moves in the displacement area is associated with the clicking operation. When detecting that the user performs the clicking operation(s) in the displacement area, the electronic device controls the control identifier to move towards the region in which the clicking operation(s) is/are performed; and the faster the clicking operation(s) is performed, the faster the control identifier moves. When the control identifier moves in the displacement area, the velocity at which the cursor moves in the interface is associated with the velocity at which the control identifier moves, and the faster the control identifier moves, the faster the cursor moves in the interface correspondingly. The correspondence relationship between each clicking operation and the distance for which the control identifier moves, and the correspondence relationship between the distance for which the control identifier moves and the distance for which the cursor moves may be set autonomously according to an actual need. For example, whenever the user performs one clicking operation, the control identifier moves for a distance of two pixels and the cursor moves for a distance of one character.

The movement operation may be, for example, the pressing operation(s). The velocity at which the control identifier moves in the displacement area is associated with the pressing operation(s). When detecting that the user performs the pressing operation(s) in the displacement area, the electronic device controls the control identifier to move towards the region in which the pressing operation(s) is/are performed. The pressure of the pressing operation may be set to be positively correlated with the velocity at which the control identifier moves, and the larger the pressure of the pressing operation detected by the electronic device, the faster the control identifier moves. When the control identifier moves in the displacement area, the velocity at which the cursor moves in the interface is associated with the velocity at which the control identifier moves, and the faster the control identifier moves, the faster the cursor moves in the interface correspondingly.

When the control identifier moves from the displacement area of the cursor control area to the continuous movement area by means of the movement operation, since the continuous movement area is the surrounding area of the cursor control area and the control identifier is unable to move further to the periphery, the cursor is controlled to continuously move in the interface at the first velocity so as to meet the requirement of the user for the continuous movement of the cursor. In this case, the cursor enters a continuously moving state until a stop-moving instruction is received to control the cursor to stop moving. The stop-moving instruction may be, for example, triggered by moving the control identifier out of the continuous movement area.

When the stop-moving instruction is not received after the cursor moves for a first preset distance in the interface at the first velocity, it is indicated that the cursor is still far away from the target position of the user at present, and then the cursor is controlled to move faster, i.e., move in the interface at a second velocity. Herein, the second velocity is greater than the first velocity.

In some embodiments of the disclosure, the cursor control area is provided to implement the movement of the cursor. The velocity at which the cursor moves is associated with the position of the control identifier in the cursor control area and the velocity at which the control identifier moves, such that the velocity at which the cursor moves is controllable, and the localization of the cursor may be achieved quickly.

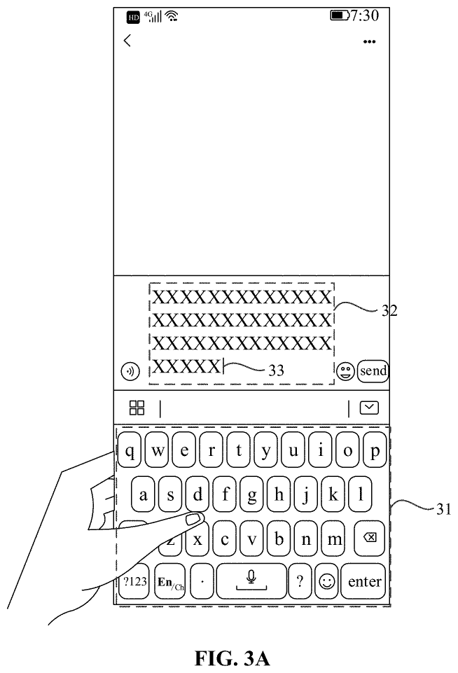

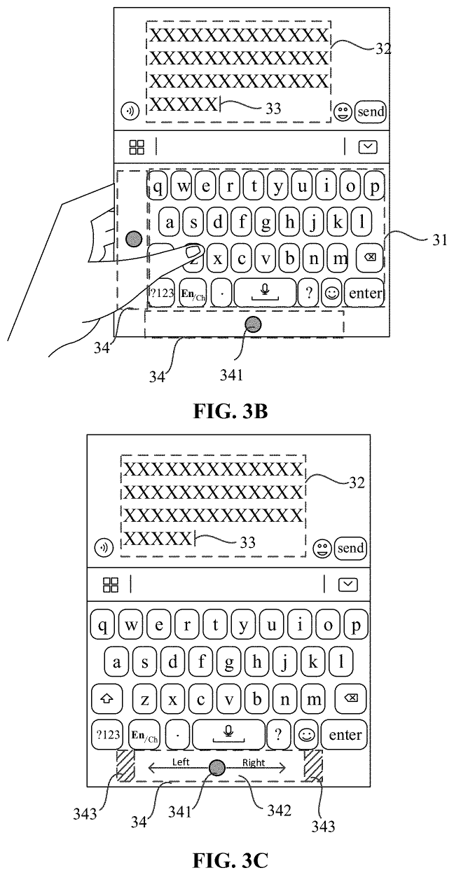

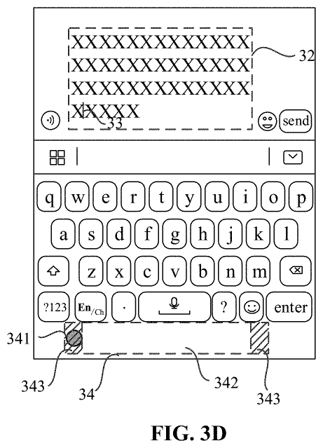

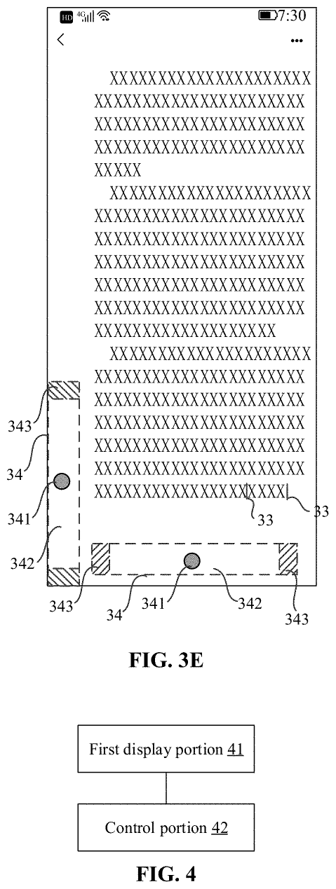

Taking a scenario of the movement of the cursor in the text editing area as an example, the specific implementation for controlling the cursor to move is further described below in combination with FIG. 2, and FIG. 3A to FIG. 3D. Referring to FIG. 2, the method may include Block 200 to Block 202.

In Block 200, a text editing interface is displayed.

Referring to FIG. 3A, the text editing interface may include a virtual keyboard 31, a text editing area 32 and a cursor 33 located at an end of the text content in the text editing area 32. The user may edit the text in the text editing area 32 with the virtual keyboard 31.

In Block 201, the cursor control area 34 is displayed in the text editing interface in response to a display instruction of a cursor control area 34.

The display instruction of the cursor control area 34 may be triggered by a user performing a target operation in the interface.

For example, the target operation may be a pressing operation acting for a preset duration in the target area of the interface. The target area where the virtual keyword 31 is located is taken as an example. Referring to FIG. 3A, when the user performs the pressing operation in the area where the virtual keyword is located, the electronic device may detect the pressing operation of the user performed on the virtual keyboard 31; and when the electronic device determines that the pressing operation has acted on the virtual keyboard 31 for more than a preset duration, referring to FIG. 3B, the cursor control area 34 is displayed in the interface.

The target operation may be, for example, a pressing operation at a preset pressure performed in the target area of the interface. The interface including the text editing area 32 and the target area of the interface where the virtual keyboard 31 is located are taken as an example. When the user performs the pressing operation in the area where the virtual keyword 31 is located, the electronic device may detect the pressing operation of the user acting on the virtual keyboard 31; and when the electronic device determines that the pressure of the pressing operation acting on the virtual keyboard 31 reaches the preset pressure, referring to FIG. 3B, the cursor control area 34 is displayed in the interface.

In order to facilitate the user operation, the cursor control area 34 is displayed at a position convenient for the user operation. When the electronic device is held by the user, the cursor control area 34 may be displayed at an edge of the interface close to a wrist of the user in the interface, and the finger of the user may perform the operation such as clicking, pressing, and sliding easily at the edge of the interface. The edge area of the interface is referred to as a finger operation hot area.

For example, when the user holds the electronic device with a single left hand, the edge of the interface close to the wrist of the user is the left edge and the bottom edge of the interface. Referring to FIG. 3B, the cursor control area 34 is displayed at the left edge and the bottom edge of the interface, and the user may select autonomously one cursor control area 34 to achieve the movement of the cursor 33. It is to be understood that when the user holds the electronic device with a right hand, the cursor control area 34 may be displayed at the right edge and the bottom edge of the interface.

It is to be noted that the number of cursor control areas 34 is not limited to two shown in the figure, and only one cursor control area 34 may be displayed in the interface. For example, when the user holds the electronic device with the single left hand, the cursor control area 34 is displayed at the left edge or the bottom edge of the interface; and when the user holds the electronic device with the single right hand, the cursor control area 34 is displayed at the right edge or the bottom edge of the interface. Three cursor control areas 34 may be alternatively displayed in the interface. For example, when the user holds the electronic device with both hands, the three cursor control areas 34 may be respectively displayed at the left edge, the bottom edge and the right edge of the interface, and the user may select autonomously one cursor control area 34 to achieve the movement of the cursor 33.

Regarding how to determine the edge of the interface close to the wrist of the user, an infrared sensor, an ultrasonic sensor, or the like may be provided at four edges of the electronic device to determine the edge of the interface close to the wrist of the user, which is not restricted and the detailed implementation thereof is not specifically limited in the disclosure.

The control identifier 341 is further provided in the cursor control area 34. The control identifier 341 may move in the cursor control area 34. The association relationship between the control identifier 341 and the cursor 33 displayed in the interface is established in advance, such that a movement of the cursor 33 may be controlled by a movement of the control identifier 341.

In Block 202, the cursor 33 is controlled to move in the text editing interface in response to a movement operation on the control identifier 341.

Referring to FIG. 3C, a scenario where the cursor control area 34 is displayed at the bottom of the interface is taken as an example. The specific implementation for the movement of the cursor 33 is further described. In FIG. 3C, the cursor control area 34 is divided into the displacement area 342 and the continuous movement area 343 surrounding the displacement area 342. When the cursor control area 34 is just displayed, the control identifier 341 is located at a central position of the displacement area 342. In response to the movement operation performed on the control identifier 341 by the user, the control identifier 341 may move in the displacement area 342 and in the continuous movement area 343. When the control identifier 341 moves in the displacement area 342, a velocity at which the cursor 33 moves in the interface is associated with a velocity at which the control identifier 341 moves; and when the control identifier 341 moves from the displacement area 342 to the continuous movement area 343, the cursor 33 moves in the interface at a first velocity.

Referring to FIG. 3C, the cursor 33 is located at the end of the text in the text editing area 32 before controlled to move. The user may trigger the movement operation on the control identifier 341 by means of pressing, clicking and sliding, which is not limited hereto. The sliding operation is taken as an example. When the user performs the sliding operation in the cursor control area 34, the control identifier 341 moves accordingly, and the velocity at which the control identifier 341 moves is positively correlated with the velocity of the sliding operation; and correspondingly, the cursor 33 moves in the text editing area 32, and the velocity at which the cursor 33 moves is positively correlated with the velocity at which the control identifier 341 moves. For example, when the user performs a leftward sliding operation in the cursor control area 34, the control identifier 341 moves leftward, and the cursor 33 moves leftward accordingly word by word in the present interface. When the user stops the sliding operation and the control identifier 341 is still located in the displacement area 342, the cursor 33 also stops moving accordingly. When the user continues to perform the leftward sliding operation, referring to FIG. 3D, to allow the control identifier 341 to move from the displacement area 342 to the continuous movement area 343, the cursor 33 continuously moves at the first velocity. In this case, the cursor 33 enters the continuously moving state, moves to the beginning of the row and autonomously moves to the end of the previous row. Before the stop-moving instruction of the user is received, the cursor 33 continuously moves leftward word by word at the first velocity. The cursor 33 does not stop moving until the stop-moving instruction is received. When the stop-moving instruction is still not received after the cursor 33 moves for a first preset distance at the first velocity, the cursor 33 is controlled to continuously move leftward word by word at a second velocity greater than the first velocity, until the stop-moving instruction is received or the cursor 33 moves to the beginning of the editing area.

In different cases, the cursor may be controlled to be localized to the target position quickly by controlling the cursor to move continuously at the first velocity and the second velocity respectively. Especially when the screen is relatively large and the cursor needs to move within a large range, the user may move the cursor to the target position with relatively less operations.

The first preset distance may be set autonomously according to an actual need, such as a distance of 10 characters. When the stop-moving instruction is not received after the cursor 33 moves for the distance of 10 characters at the first velocity, the cursor moves continuously at the second velocity.

The stop-moving instruction may be, for example, triggered by moving the control identifier 341 out of the continuous movement area 343 to the displacement area 342, i.e., when the control identifier 341 moves out of the continuous movement area 343 to the displacement area 342, the control identifier 341 exits from the continuously moving state.

In order to avoid identifying falsely, as the stop-moving instruction of the cursor 33, the movement of the control identifier 341 from the continuous movement area 343 back to the displacement area 342 due to muscle twitches, a continuous movement buffer area may be provided between the displacement area 342 and the continuous movement area 343. When the control identifier 341 moves back to the displacement area 342 from the continuous movement area 343 through the continuous movement buffer region, i.e., only when the control identifier 341 is far away from the displacement area 342, the cursor 33 exits from the continuously moving state.

In any of the above-mentioned embodiments, the cursor 33 may further move in combination with a vibration prompt. Whenever the cursor 33 moves for a second preset distance, a first vibration prompt is triggered, so as to inform the user that the cursor 33 completes one movement. The second preset distance may be, for example, a distance of one character displayed in the interface. The cursor 33 vibrates once whenever moving for a distance of one character.

A second vibration prompt is triggered when the control identifier 341 moves from the displacement area 342 to the continuous movement area 343, and a vibration strength of the second vibration prompt is greater than a vibration strength of the first vibration prompt. That is, when the control identifier 341 enters the continuous movement area 343, one strong vibration is given to inform the user that the cursor 33 enters the continuously moving state. In order to avoid the discomfort brought to the user due to the strong vibration, the vibration prompt is stopped after the cursor 33 enters the continuously moving state. By giving different vibration feedbacks when the cursor 33 moves and enters the continuously moving state, the user experience is better.

The methods for cursor control provided in any of the above-mentioned embodiments is further applied to a scenario of selecting a text content in the text interface. Referring to FIG. 3E, when selecting the text content, two cursors are displayed in the interface, and the content between the two cursors represents the presently selected text content. In the embodiment of the disclosure, two cursor control areas are displayed. The two cursor control areas correspond respectively to one cursor, and are arranged to control the movement and localization of the cursor. The control on each cursor is similar to the control on the movement of the cursor in the text editing area, and referring to Block 201 and Block 202, the details are not elaborated herein.

Corresponding to the above-mentioned embodiments for the method for cursor control, the disclosure also provides an embodiment for a cursor control apparatus.

FIG. 4 is a structure schematic diagram illustrating a cursor control apparatus according to some embodiments of the present disclosure. The cursor control apparatus is applied to an electronic device. The electronic device includes a touch screen, and an interface displayed on the touch screen includes a cursor.

The apparatus may include a first display portion 41 and a control portion 42.

The first display portion 41 is configured to display the cursor control area in the interface in response to a display instruction of a cursor control area. The cursor control area includes a displacement area and a continuous movement area surrounding the displacement area, and a control identifier is further provided in the cursor control area and is capable of moving in the cursor control area.

The control portion 42 is configured to control the cursor to move in the interface in response to a movement operation on the control identifier. When the control identifier moves in the displacement area, a velocity at which the cursor moves in the interface is associated with a velocity at which the control identifier moves; and when the control identifier moves from the displacement area to the continuous movement area, the cursor moves in the interface at a first velocity.

In some embodiments, the apparatus may further include a second display portion and a detection portion.

The second display portion displays a virtual keyboard in the interface.

The detection portion is configured to call the first display portion to display the cursor control area when detecting that a touch operation has acted on the virtual keyword for more than a preset duration; or, call the first display portion to display the cursor control area when detecting that a pressure of the touch operation acting on the virtual keyboard exceeds a pressure threshold.

In some embodiments, when the cursor control area is displayed in the interface, the first display portion 41 is configured to:

display the cursor control area at an edge of the interface close to a wrist of the user when the electronic device is held by a user.

In some embodiments, the control portion 42 is further configured to:

control the cursor to move in the interface at a second velocity when a stop-moving instruction is not received after the cursor moves for a first preset distance in the interface at the first velocity. Herein, the second velocity is greater than the first velocity.

In some embodiments, when the control identifier moves from the continuous movement area back to the displacement area, the control portion 42 is further configured to control the cursor to stop moving.

In some embodiments, a continuous movement buffer region is further provided between the displacement area and the continuous movement area.

When the control identifier moves from the continuous movement area back to the displacement area through the continuous movement buffer region, the control portion 42 is further configured to control the cursor to stop moving.

In some embodiments, the apparatus may further include a trigger portion.

The trigger portion is configured to trigger a first vibration prompt whenever the cursor moves for a second preset distance.

In some embodiments, the trigger portion is further configured to trigger a second vibration prompt when the control identifier moves from the displacement area to the continuous movement area. A vibration strength of the second vibration prompt is greater than a vibration strength of the first vibration prompt.

Regarding the apparatus in the above-mentioned embodiment, the specific manners in which the portions perform the operations are described in detail in the related method embodiments, and are not elaborated herein.

Since the device embodiments basically correspond to the method embodiments, references may be made to the description in the method embodiments with respect to the relevant parts. The above described apparatus embodiments are merely exemplary. The portions described as separate parts may or may not be physically separate, and the parts displayed as portions may or may not be physical units, i.e., may be located at one position, or may be distributed on multiple network portions. Some or all of the portions may be selected according to actual needs to achieve the objectives of the solutions in the embodiments. Those of ordinary skill in the art may understand and implement the embodiments without creative work.

The embodiment of the disclosure further provides an electronic device. The electronic device includes:

a processor; and

a memory, configured to store instructions executable by the processor.

The processor is configured to implement the method for cursor control in any one of the above-mentioned embodiments.

The embodiment of the disclosure further provides a computer-readable storage medium storing thereon a computer program which, when performed by a processor, implements the steps of the method for cursor control of any one of the above-mentioned embodiments.

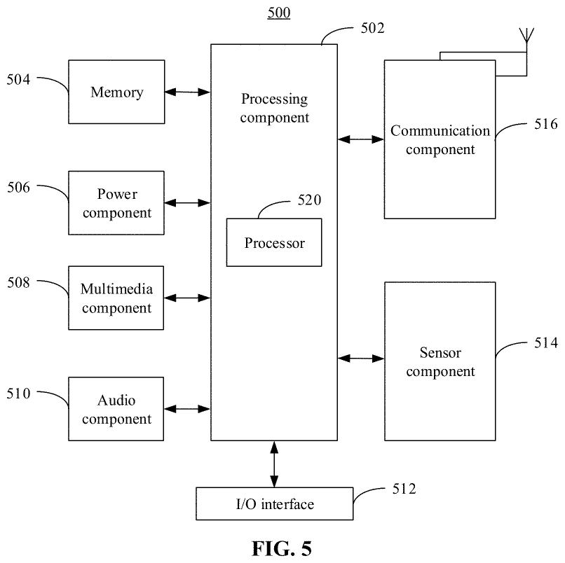

FIG. 5 is a block diagram of an apparatus for cursor control according to some embodiments of the present disclosure. The apparatus may be a mobile phone, a computer, a digital broadcasting terminal, a messaging device, a game console, a tablet, a medical device, an exercise equipment, a PDA, or the like.

As shown in FIG. 5, the apparatus 500 may include one or more of the following components: a processing component 502, a memory 504, a power component 506, a multimedia component 508, an audio component 510, an Input/Output (I/O) interface 512, a sensor component 514, and a communication component 516. The apparatus may further include an antenna module (for example, an antenna module which may be connected to the communication component 516).

The processing component 502 typically controls the overall operations of the apparatus 500, such as the operations associated with display, telephone calls, data communications, camera operations, or recording operations. The processing component 502 may include one or more processors 520 to perform instructions to implement all or part of the steps in the above-described methods. Moreover, the processing component 502 may include one or more modules to facilitate the interaction between the processing component 502 and other components. For instance, the processing component 502 may include a multimedia module to facilitate the interaction between the multimedia component 508 and the processing component 502.

The memory 504 is configured to store various types of data to support the operations in the apparatus 500. Examples of such data include instructions for any applications or methods operated on the apparatus 500, contact data, phonebook data, messages, pictures, videos, etc. The memory 504 may be implemented by using any type of volatile or non-volatile memory devices, or a combination thereof, such as an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power component 506 provides power to various components of the apparatus 500. The power component 506 may include a power management system, one or more power sources, and any other components associated with the generation, management, and distribution of power for the apparatus 500.

The multimedia component 508 includes a screen providing an output interface between the apparatus 500 and the user. In some embodiments, the screen may include a Liquid Crystal Display (LCD) and a Touch Panel (TP). In some embodiments, organic light-emitting diode (OLED) or other types of displays can be employed. When the screen includes the TP, the screen may be implemented as a touch screen to receive an input signal from the user. The TP includes one or more touch sensors to sense touches, slides and gestures on the TP. The touch sensors may not only sense a boundary of a touch or a slide, but also sense a duration and a pressure associated with the touch or the slide. In some embodiments, the multimedia component 508 includes a front camera and/or a rear camera. The front camera and/or the rear camera may receive external multimedia data when the apparatus 500 is in an operation mode, such as a shooting mode or a video mode. Each of the front camera and the rear camera may be a fixed optical lens system or have a focus and an optical zoom capability.

The audio component 510 is configured to output and/or input audio signals. For example, the audio component 510 includes a microphone (MIC) configured to receive an external audio signal when the apparatus 500 is in an operation mode, such as a call mode, a recording mode, and a voice recognition mode. The received audio signal may be further stored in the memory 504 or transmitted via the communication component 516. In some embodiments, the audio component 510 further includes a speaker configured to output audio signals.

The I/O interface 512 provides an interface between the processing component 502 and peripheral interface modules. The peripheral interface modules may be a keyboard, a click wheel, a button, or the like. The button may include, but is not limited to, a home button, a volume button, a start button, and a lock button.

The sensor component 514 includes one or more sensors to provide state assessments in various aspects for the apparatus 500. For instance, the sensor component 514 may detect an on/off state of the apparatus 500, and relative positioning of the components such as a display and small keyboard of the apparatus 500. The sensor component 514 may further detect a change in a position of the apparatus 500 or a change in a position of a component of the apparatus 500, the presence or absence of contact between the user and the apparatus 500, the orientation or acceleration/deceleration of the apparatus 500, or a change in a temperature of the apparatus 500. The sensor component 514 may include a proximity sensor configured to detect the presence of nearby objects without any physical contacts. The sensor component 514 may further include a light sensor such as a complementary metal oxide semiconductor (CMOS) or a charge coupled device (CCD) image sensor, configured for usage in an imaging application. In some embodiments, the sensor component 514 may further include an acceleration sensor, a gyroscope sensor, a magnetic sensor, a pressure sensor, or a temperature sensor.

The communication component 516 is configured to facilitate the wired or wireless communication between the apparatus 500 and other devices. The apparatus 500 may access a communication-standard-based wireless network such as wireless fidelity (Wi-Fi), 2nd-Generation (2G), 3rd-Generation (3G), 4^{th}-Generation (4G), or 5^{th}-Generation (5G) network or a combination thereof. In some embodiments, the communication component 516 receives a broadcast signal or information associated with broadcast from an external broadcast management system via a broadcast channel. In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra wideband (UWB) technology, a bluetooth (BT) technology, or other technologies.

In some embodiments, the apparatus 500 may be implemented with one or more application specific integrated circuit (ASIC), digital signal processor (DSP), digital signal processing device (DSPD), programmable logic device (PLD), field programmable gate array (FPGA), controller, microcontroller, microprocessor, or other electronic components, for executing the methods in any one of the above-mentioned embodiments.

In some embodiments, a non-transitory computer readable storage medium including instructions is further provided, such as the memory 504 including the instructions, and the instructions may be executed by the processing component 520 of the apparatus 500 to implement the above-mentioned methods. For example, the non-transitory computer-readable storage medium may be a read only memory (ROM), a random-access memory (RAM), a compact disc read-only memory (CD-ROM), a magnetic tape, a floppy disc, an optical data storage device or the like.

The various device components, modules, units, blocks, or portions may have modular configurations, or are composed of discrete components, but nonetheless can be referred to as “modules” in general. In other words, the “components,” “modules,” “blocks,” “portions,” or “units” referred to herein may or may not be in modular forms.

In the present disclosure, the terms “installed,” “connected,” “coupled,” “fixed” and the like shall be understood broadly, and can be either a fixed connection or a detachable connection, or integrated, unless otherwise explicitly defined. These terms can refer to mechanical or electrical connections, or both. Such connections can be direct connections or indirect connections through an intermediate medium. These terms can also refer to the internal connections or the interactions between elements. The specific meanings of the above terms in the present disclosure can be understood by those of ordinary skill in the art on a case-by-case basis.

In the description of the present disclosure, the terms “one embodiment,” “some embodiments,” “example,” “specific example,” or “some examples,” and the like can indicate a specific feature described in connection with the embodiment or example, a structure, a material or feature included in at least one embodiment or example. In the present disclosure, the schematic representation of the above terms is not necessarily directed to the same embodiment or example.

Moreover, the particular features, structures, materials, or characteristics described can be combined in a suitable manner in any one or more embodiments or examples. In addition, various embodiments or examples described in the specification, as well as features of various embodiments or examples, can be combined and reorganized.

In some embodiments, the control and/or interface software or app can be provided in a form of a non-transitory computer-readable storage medium having instructions stored thereon is further provided. For example, the non-transitory computer-readable storage medium can be a ROM, a CD-ROM, a magnetic tape, a floppy disk, optical data storage equipment, a flash drive such as a USB drive or an SD card, and the like.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium can be tangible.

The operations described in this disclosure can be implemented as operations performed by a data processing apparatus on data stored on one or more computer-readable storage devices or received from other sources.

The devices in this disclosure can include special purpose logic circuitry, e.g., an FPGA (field-programmable gate array), or an ASIC (application-specific integrated circuit). The device can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The devices and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and it can be deployed in any form, including as a stand-alone program or as a portion, component, subroutine, object, or other portion suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more portions, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA, or an ASIC.

Processors or processing circuits suitable for the execution of a computer program include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented with a computer and/or a display device, e.g., a VR/AR device, a head-mount display (HMD) device, a head-up display (HUD) device, smart eyewear (e.g., glasses), a CRT (cathode-ray tube), LCD (liquid-crystal display), OLED (organic light emitting diode), or any other monitor for displaying information to the user and a keyboard, a pointing device, e.g., a mouse, trackball, etc., or a touch screen, touch pad, etc., by which the user can provide input to the computer.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components.

The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination.

Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized.

It is intended that the specification and embodiments be considered as examples only. Other embodiments of the disclosure will be apparent to those skilled in the art in view of the specification and drawings of the present disclosure. That is, although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the example embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

It should be understood that “a plurality” or “multiple” as referred to herein means two or more. “And/or,” describing the association relationship of the associated objects, indicates that there may be three relationships, for example, A and/or B may indicate that there are three cases where A exists separately, A and B exist at the same time, and B exists separately. The character “I” generally indicates that the contextual objects are in an “or” relationship.

In the present disclosure, it is to be understood that the terms “lower,” “upper,” “under” or “beneath” or “underneath,” “above,” “front,” “back,” “left,” “right,” “top,” “bottom,” “inner,” “outer,” “horizontal,” “vertical,” and other orientation or positional relationships are based on example orientations illustrated in the drawings, and are merely for the convenience of the description of some embodiments, rather than indicating or implying the device or component being constructed and operated in a particular orientation. Therefore, these terms are not to be construed as limiting the scope of the present disclosure.

Moreover, the terms “first” and “second” are used for descriptive purposes only and are not to be construed as indicating or implying a relative importance or implicitly indicating the number of technical features indicated. Thus, elements referred to as “first” and “second” may include one or more of the features either explicitly or implicitly. In the description of the present disclosure, “a plurality” indicates two or more unless specifically defined otherwise.

In the present disclosure, a first element being “on” a second element may indicate direct contact between the first and second elements, without contact, or indirect geometrical relationship through one or more intermediate media or layers, unless otherwise explicitly stated and defined. Similarly, a first element being “under,” “underneath” or “beneath” a second element may indicate direct contact between the first and second elements, without contact, or indirect geometrical relationship through one or more intermediate media or layers, unless otherwise explicitly stated and defined.

Some other embodiments of the present disclosure can be available to those skilled in the art upon consideration of the specification and practice of the various embodiments disclosed herein. The present application is intended to cover any variations, uses, or adaptations of the present disclosure following general principles of the present disclosure and include the common general knowledge or conventional technical means in the art without departing from the present disclosure. The specification and examples can be shown as illustrative only, and the true scope and spirit of the disclosure are indicated by the following claims.

1. A method for cursor control, comprising:
displaying, by an electronic device comprising a touch screen that displays an interface on the touch screen, a cursor control area in the interface in response to a display instruction of the cursor control area, wherein the interface comprises a cursor, the cursor control area comprises a displacement area and a continuous movement area surrounding the displacement area, and the cursor control area further comprises a control identifier capable of moving in the cursor control area; wherein a continuous movement buffer region is further placed between the displacement area and the continuous movement area;
controlling, by the electronic device, the cursor to move in the interface in response to a movement operation on the control identifier;
in response to determining that the control identifier moves in the displacement area, associating a cursor velocity at which the cursor moves in the interface with a control identifier velocity at which the control identifier moves;
in response to determining that the control identifier moves from the displacement area to the continuous movement area, moving the cursor in the interface at a first velocity; and
controlling, by the electronic device, the cursor to stop moving in response to determining that the control identifier moves from the continuous movement area back to the displacement area through the continuous movement buffer region.

2. The method of claim 1, further comprising:
displaying, by the electronic device, a virtual keyboard in the interface; and
displaying, by the electronic device, the cursor control area in response to detecting that a touch operation has acted on a virtual keyword for more than a preset duration; or
displaying the cursor control area in response to detecting that a pressure of the touch operation acting on the virtual keyboard exceeds a pressure threshold.

3. The method of claim 1, wherein displaying the cursor control area in the interface comprises:
displaying the cursor control area at an edge of the interface close to a wrist of a user holding the electronic device.

4. The method of claim 1, further comprising:
controlling, by the electronic device, the cursor to move in the interface at a second velocity in response to determining that a stop-moving instruction is not received after the cursor has moved for a first preset distance in the interface at the first velocity, wherein the second velocity is greater than the first velocity.

5. The method of claim 1, further comprising:
controlling, by the electronic device, the cursor to stop moving in response to determining that the control identifier moves from the continuous movement area back to the displacement area.

6. (canceled)

7. The method of claim 1, further comprising:
triggering, by the electronic device, a first vibration prompt each time in response to determining that the cursor moves for a second preset distance.

8. The method of claim 7, further comprising:
triggering, by the electronic device, a second vibration prompt in response to determining that the control identifier moves from the displacement area to the continuous movement area, wherein a vibration strength of the second vibration prompt is greater than a vibration strength of the first vibration prompt.

9. An electronic device, comprising:
a processor; and
a memory, configured to store instructions executable by the processor,
wherein the processor is configured to:
display a cursor control area in an interface in response to a display instruction of the cursor control area, wherein the electronic device comprises a touch screen that displays the interface on the touch screen, the interface comprises a cursor, the cursor control area comprises a displacement area and a continuous movement area surrounding the displacement area, and the cursor control area further comprises a control identifier capable of moving in the cursor control area; wherein a continuous movement buffer region is further placed between the displacement area and the continuous movement area;
control the cursor to move in the interface in response to a movement operation on the control identifier;
in response to determining that the control identifier moves in the displacement area, associate a cursor velocity at which the cursor moves in the interface with a control identifier velocity at which the control identifier moves;
in response to determining that the control identifier moves from the displacement area to the continuous movement area, move the cursor in the interface at a first velocity; and
control the cursor to stop moving in response to determining that the control identifier moves from the continuous movement area back to the displacement area through the continuous movement buffer region.

10. The electronic device of claim 9, wherein the processor is further configured to:
display a virtual keyboard in the interface; and
display the cursor control area in response to detecting that a touch operation has acted on a virtual keyword for more than a preset duration; or display the cursor control area in response to detecting that a pressure of the touch operation acting on the virtual keyboard exceeds a pressure threshold.

11. The electronic device of claim 9, wherein the processor is configured to display the cursor control area in the interface further comprises that the processor is configured to:
display the cursor control area at an edge of the interface close to a wrist of a user holding the electronic device.

12. The electronic device of claim 9, wherein the processor is further configured to:
control the cursor to move in the interface at a second velocity in response to determining that a stop-moving instruction is not received after the cursor has moved for a first preset distance in the interface at the first velocity, wherein the second velocity is greater than the first velocity.

13. The electronic device of claim 1, wherein the processor is further configured to:
control the cursor to stop moving in response to determining that the control identifier moves from the continuous movement area back to the displacement area.

14. (canceled)

15. The electronic device of claim 1, wherein the processor is further configured to:
trigger a first vibration prompt each time in response to determining that the cursor moves for a second preset distance.

16. The electronic device of claim 7, wherein the processor is further configured to:
trigger a second vibration prompt in response to determining that the control identifier moves from the displacement area to the continuous movement area, wherein a vibration strength of the second vibration prompt is greater than a vibration strength of the first vibration prompt.

17. A non-transitory computer-readable storage medium storing thereon a computer program which, when performed by a processor of an electronic device, implements acts comprising:
displaying a cursor control area in an interface displayed on a touch screen of the electronic device in response to a display instruction of the cursor control area, wherein the cursor control area comprises a displacement area and a continuous movement area surrounding the displacement area, and the cursor control area comprises a control identifier capable of moving in the cursor control area; wherein a continuous movement buffer region is further placed between the displacement area and the continuous movement area;
controlling a cursor in the interface to move in the interface in response to a movement operation on the control identifier;
in response to determining that the control identifier moves in the displacement area, associating a cursor velocity at which the cursor moves in the interface with a control identifier velocity at which the control identifier moves; and
in response to determining that the control identifier moves from the displacement area to the continuous movement area, moving the cursor in the interface at a first velocity; and
controlling the cursor to stop moving in response to determining that the control identifier moves from the continuous movement area back to the displacement area through the continuous movement buffer region.

18. The non-transitory computer-readable storage medium of claim 17, wherein the computer program implements acts further comprising:
displaying a virtual keyboard in the interface; and
displaying the cursor control area in response to detecting that a touch operation has acted on a virtual keyword for more than a preset duration; or displaying the cursor control area in response to detecting that a pressure of the touch operation acting on the virtual keyboard exceeds a pressure threshold.

19. The non-transitory computer-readable storage medium of claim 17, wherein displaying the cursor control area in the interface comprises:
displaying the cursor control area at an edge of the interface close to a wrist of a user holding the electronic device.

20. The non-transitory computer-readable storage medium of claim 17, wherein the computer program implements acts further comprising:
controlling the cursor to move in the interface at a second velocity in response to determining that a stop-moving instruction is not received after the cursor has moved for a first preset distance in the interface at the first velocity, wherein the second velocity is greater than the first velocity.
